(19) United States
(12) Patent Application Publication
(10) Pub. No.: US 2018/0343825 A1
(43) Pub. Date: Dec. 6, 2018

(54) REUSABLE CAT LITTER AND METHOD FOR MANUFACTURING THE SAME

(71) Applicant: CHIUNG-YEH CHANG, TAINAN CITY (TW)

(72) Inventors: HAO-CHIEH CHANG, TAINAN CITY (TW); JUI-CHEN CHANG, TAINAN CITY (TW)

(21) Appl. No.: 15/996,851

(22) Filed: Jun. 4, 2018

(30) Foreign Application Priority Data
Jun. 5, 2017 (TW) 106118552

(51) Int. Cl. A01K 1/015; B01J 6/00

(52) U.S. Cl. CPC A01K 1/0154; B01J 6/001; A01K 1/0155

(57) ABSTRACT

A reusable cat litter and a method for manufacturing the same are disclosed. The method includes a raw material pretreatment step: providing a shell powder performed with a calcination treatment, the calcination treatment being performed at a temperature range of 500-1200° C.; and a mixing and granulation step: mixing and granulating 70-90 parts by weight of the shell powder and 10-30 parts by weight of a non-adhesive powder to form the cat litter. Wherein, the shell powder has a particle size of 80-8000 mesh. The cat litter has a better deodorization effect and will not clump and can be reused after cleaning.

### FIELD OF THE INVENTION

The present invention relates to a reusable cat litter and a method for manufacturing the same, and more particularly to a method by mixing and granulating a shell powder and a non-adhesive powder to form the cat litter that has a deodorization effect and can be reused.

### BACKGROUND OF THE INVENTION

Cat litter, invented by American Edward Lowe in 1947, is a substance for cats to cover feces and urine. Conventional cat litter may be classified into two categories, clumping cat litter and non-clumping cat litter. Wherein, non-clumping cat litter does not clump when mixed with the urine. After the cat defecates, the cat litter can be shoveled out and needs to be replaced after use.

The common non-clumping cat litter is crystal cat litter. The ingredient of crystal cat litter is silicone, having a micro-porous structure therein. The micro-porous structure is adapted to absorb urine and water. Crystal cat litter has the advantages of long service life, no dust, and good cleanliness.

However, crystal cat litter is expensive and its deodorization effect is poor. Cats do not like the silicone material and sometimes don't use crystal cat litter.

Accordingly, the inventor of the present invention has devoted himself based on his many years of practical experiences to solve these problems.

### SUMMARY OF THE INVENTION

The primary object of the present invention is to provide a porous non-clumping cat litter made from shell powder and has the advantage of good deodorization, so as to solve the shortcomings of crystal cat litter.

According to one aspect of the present invention, a reusable cat litter is provided. The reusable cat litter comprises 70-90 parts by weight of a shell powder and 10-30 parts by weight of a non-adhesive powder to be mixed and granulated. Wherein, the shell powder has a particle size of 80-8000 mesh. Preferably, the shell powder has a particle size of 5000 mesh.

Preferably, the powder is one of polymer powder, metal powder and ore powder.

Preferably, the reusable cat litter further comprises 0.1-20 parts by weight of a plant fiber. Preferably, the plant fiber has a particle size of 80-200 mesh. Preferably, the plant fiber is an agricultural waste and residue, including one of coffee grounds, wood flour, bamboo powder and rice straw powder or a combination thereof.

According to another aspect of the present invention, a method for manufacturing a reusable cat litter. The method comprises a raw material pretreatment step: providing a shell powder performed with a calcination treatment, the calcination treatment being performed at a temperature range of 500-1200° C.; and a mixing and granulation step: mixing and granulating 70-90 parts by weight of the shell powder and 10-30 parts by weight of a non-adhesive powder, wherein the shell powder has a particle size of 80-8000 mesh.

Preferably, a shell is first performed with the calcination treatment and then ground into the shell powder. Alternatively, a shell is first ground into the shell powder and then performed with the calcination treatment.

According to the above technical features, the present invention has the following advantages:

1. The shell powder is a calcium carbonate structure. After calcination, it becomes a calcium oxide structure. Calcium oxide has a better deodorizing function than calcium carbonate. Therefore, it can reduce the odor generated by cat's fecal excrement.

2. The cat litter uses the natural ingredients of shell powder, and plant fibers or agricultural wastes and residues (such as coffee grounds, wood flour, bamboo powder, rice straw powder, etc.) may be added according to the needs. On the one hand, it can prevent the product from causing harm to the environment, and on the other hand it can avoid harming the health of pets or owners.

3. The shell powder has a particle size of 5000 mesh (powdered particle size of 2.6 μm), and the plant fiber has a particle size of 80-200 mesh (particle size of 200-75 μm), having the advantages of easy grinding and low cost.

### BRIEF DESCRIPTION OF THE DRAWINGS

FIG. 1 is a block diagram of a manufacturing process according to an embodiment of the present invention; and

FIG. 2 is a schematic view of a manufacturing process according to an embodiment of the present invention.

### DETAILED DESCRIPTION OF THE PREFERRED EMBODIMENTS

Embodiments of the present invention will now be described, by way of example only, with reference to the accompanying drawings.

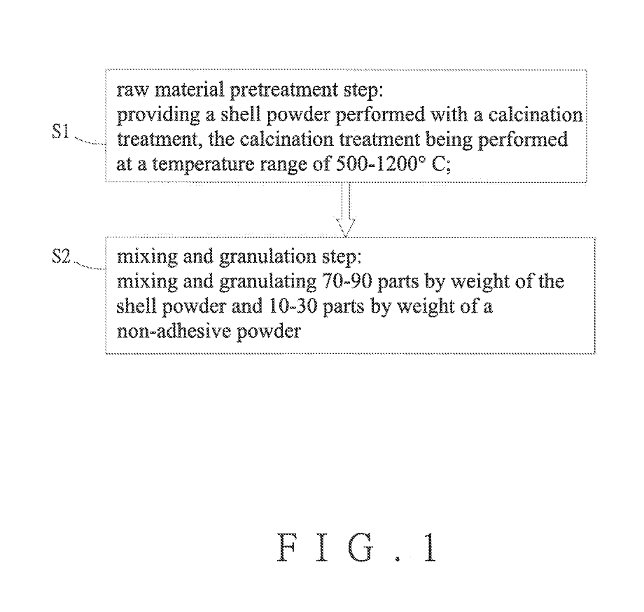

Referring to FIG. 1, the present invention discloses a method for manufacturing a reusable cat litter, comprising a raw material pretreatment step (S1) and a mixing and granulation step (S2).

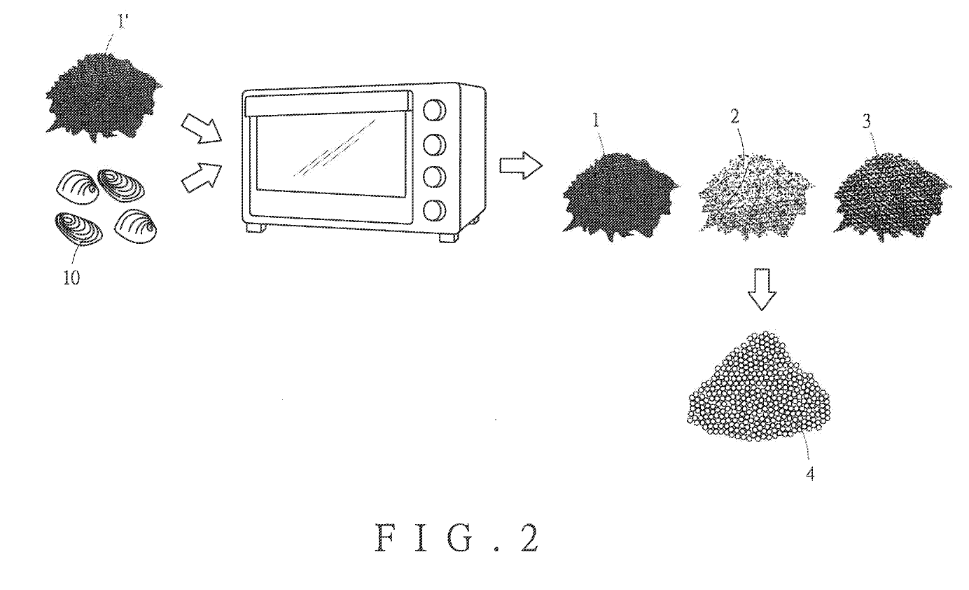

Referring to FIG. 1 and FIG. 2, the raw material pretreatment step (S1) provides a shell powder (1) performed with a calcination treatment. For example, the calcination treatment uses a calciner. The calcination treatment is performed at a temperature range of 500-1200° C., so that the calcium carbonate that is the main ingredient of the shell powder (1) can be partially or completely converted into calcium oxide, changing its microstructure to enhance its adsorption and deodorization effect.

The mixing and granulation step (S2) is to mix and granulate 70-90 parts by weight of the shell powder (1), 10-30 parts by weight of a non-adhesive powder (2), and 0.1-20 parts by weight of a plant fiber (3). Wherein, the shell powder (1) has a particle size of 80-8000 mesh. Preferably, the shell powder (1) has a particle size of about 5000 mesh, thereby having an appropriate porosity after mixing and granulation. It should be noted that at least one shell (10) is first ground into a shell powder (1′) having a predetermined particle size and then performed with a calcination treatment to obtain the desired shell powder (1). The shell (10) may be first performed with a calcination treatment and then ground into the shell powder (1), but not limited to the above embodiment. The powder (2) may be one of polymer powder, metal powder and ore powder. The plant fiber (3) has a particle size of 80-200 mesh, and may be an agricultural waste and residue, such as coffee grounds, wood flour, bamboo powder or rice straw powder or a combination thereof. The cat litter (4) of the present invention can be obtained through the mixing granulation step (S2). The cat litter (4) may be in the form of a cylinder or sphere of 1-2 mm, but not limited thereto. When the cat litter (4) is mixed with cat urine and feces, it will not clump and can be reused after cleaning.

Although particular embodiments of the present invention have been described in detail for purposes of illustration, various modifications and enhancements may be made without departing from the spirit and scope of the present invention. Accordingly, the present invention is not to be limited except as by the appended claims.

What is claimed is:

1. A reusable cat litter, comprising 70-90 parts by weight of a shell powder and 10-30 parts by weight of a non-adhesive powder to be mixed and granulated, wherein the shell powder has a particle size of 80-8000 mesh.

2. The reusable cat litter as claimed in claim 1, wherein the powder is one of polymer powder, metal powder and ore powder.

3. The reusable cat litter as claimed in claim 1, wherein the shell powder has a particle size of 5000 mesh.

4. The reusable cat litter as claimed in claim 1, further comprising 0.1-20 parts by weight of a plant fiber.

5. The reusable cat litter as claimed in claim 4, wherein the plant fiber has a particle size of 80-200 mesh.

6. The reusable cat litter as claimed in claim 4, wherein the plant fiber is one of coffee grounds, wood flour, bamboo powder and rice straw powder or a combination thereof.

7. The reusable cat litter as claimed in claim 4, wherein the plant fiber is an agricultural waste and residue.

8. A method for manufacturing a reusable cat litter, comprising:
a raw material pretreatment step: providing a shell powder performed with a calcination treatment, the calcination treatment being performed at a temperature range of 500-1200° C.;
a mixing and granulation step: mixing and granulating 70-90 parts by weight of the shell powder and 10-30 parts by weight of a non-adhesive powder, wherein the shell powder has a particle size of 80-8000 mesh.

9. The method as claimed in claim 8, wherein a shell is first performed with the calcination treatment and then ground into the shell powder.

10. The method as claimed in claim 8, wherein a shell is first ground into the shell powder and then performed with the calcination treatment.
